(19) United States
(12) Patent Application Publication
(10) Pub. No.: US 2020/0286179 A1
(43) Pub. Date: Sep. 10, 2020

(54) System and Method for Visualizing Pricing Deviations Across Time

(71) Applicant: CIBC World Markets Inc., Toronto (CA)

(72) Inventors: Tushar ARORA, Toronto (CA); Oleg SVIRSCHI, Oakville (CA)

(21) Appl. No.: 16/809,472

(22) Filed: Mar. 4, 2020

Related U.S. Application Data
(60) Provisional application No. 62/814,217, filed on Mar. 5, 2019.

(51) Int. Cl. G06Q 40/06; B33Y 80/00; G09B 23/02

(52) U.S. Cl. CPC G06Q 40/06; G09B 23/02; B33Y 80/00

(57) ABSTRACT

A system and method are provided comprising: a) for a specified underlying and tenor, generating a two-dimensional surface showing prices for different strikes at a specific point in time; b) repeating a) for a plurality of points in time; c) connecting the two-dimensional surfaces to generate a three-dimensional block; d) cutting a surface of the three-dimensional block along a spot for each point in time to identifying how pricing has deviated from a Q measure across time; and e) generating a three-dimensional visualization in one or more formats.

### CROSS-REFERENCE TO RELATED APPLICATION(S)

The present application claims priority from U.S. Provisional Application No. 62/814,217 filed on Mar. 5, 2019 incorporated herein in its entirety.

### TECHNICAL FIELD

The following relates to systems and methods for visualizing pricing deviations in financial derivatives across time and can include generating a three-dimensional rendering in one or more physical or virtual formats.

### BACKGROUND

There exist two separate branches of mathematical finance that are found to require advanced quantitative techniques. The first branch is the “Q” area of derivatives pricing, whose task is to “extrapolate the present”. The second branch is known as the “P” area of quantitative risk and portfolio management, whose task is to “model the future”.

Active Portfolio Management (i.e., hedging and alpha generation) requires that one intuitively, but precisely, connect the “P” area of finance to the “Q” area of finance.

It is an object of the following to at least in part address this requirement to connect the P area of finance with the Q area of finance.

### SUMMARY

There is provided a system and method for visualizing pricing deviations across time by generating and rendering a three-dimensional output in a physical and/or virtual format to enable one to intuitively connect the P and Q areas of finance. The following relates to all major assets classes and is not limited to any particular example provided herein.

In one aspect, there is provided a method comprising: a) for a specified underlying and tenor, generating a two-dimensional surface showing prices for different strikes at a specific point in time; b) repeating a) for a plurality of points in time; c) connecting the two-dimensional surfaces to generate a three-dimensional block; d) cutting a surface of the three-dimensional block along the spot level of the underlying derivative for each point in time to identify how pricing has deviated from a Q measure across time; and e) generating a three-dimensional visualization in one or more formats.

In other aspects, there are provided a system and computer readable medium storing instructions for implementing the method.

### BRIEF DESCRIPTION OF THE DRAWINGS

Embodiments will now be described with reference to the appended drawings wherein:

FIG. 1 is a schematic block diagram of a system for visualizing pricing deviations across time and generating a three-dimensional rendering in one or more physical or virtual formats;

FIG. 2 is a flow diagram illustrating computer executable operations performed in visualizing pricing deviations across time and generating a three-dimensional rendering in one or more physical or virtual formats; and

FIG. 3 is an illustration of an example of a 3D model.

FIG. 4 is a further illustration of an example of a 3D model.

FIG. 5 is yet another illustration of an example of a 3D model.

### DETAILED DESCRIPTION

It is recognized that the “Q” area, or the “risk-neutral measure”, i.e., the price to buy (or sell) a derivative on an “underlying”, can be very different from historic realizations of the “underlying”.

For instance, Euro Stoxx 50 is the signature benchmark index in the Euro Zone. Historically, data suggests that Euro Stoxx 50 has been up 15%, or more, over 5 years about 60% of the time. However, current option pricing suggests that the price for buying a derivative that pays $1 when Euro Stoxx 50 is up 15%, or more (and pays 0 otherwise), over 5 years is (only) 20%. Therefore, as the price today of the derivative is very different from the historic outcomes (Price/Historic Outcomes=20%/60%=⅓), this presents an opportunity for portfolio managers to potentially outperform the “market” and generate “alpha”, which is often referred to as an “excess return” above a specified “cash” benchmark such as the Euro Stoxx 50.

The above example illustrates one specific alpha opportunity for a specific move in Euro Stoxx 50. However, this raises a question of how could one build a way to isolate this opportunity not just for the 15% level, but also the 20% level, the 25% level, the 30% level and so on and so forth? Moreover, this also raises the question of could one also gauge the market pricing for each of these levels not just today but also across time?

It has been found that these facets require that one build a 3-dimensional surface, where one axis represents the different points in time, the second axis the 15%, 20%, 25% etc. “strikes”, and finally the third axis, the price of buying each of these strikes, as it has evolved over time.

The system described herein determines and renders a three-dimensional model that can precisely isolate the difference between the risk neutral measure, “Q” and the real-world measure, “P”, across a specified time period.

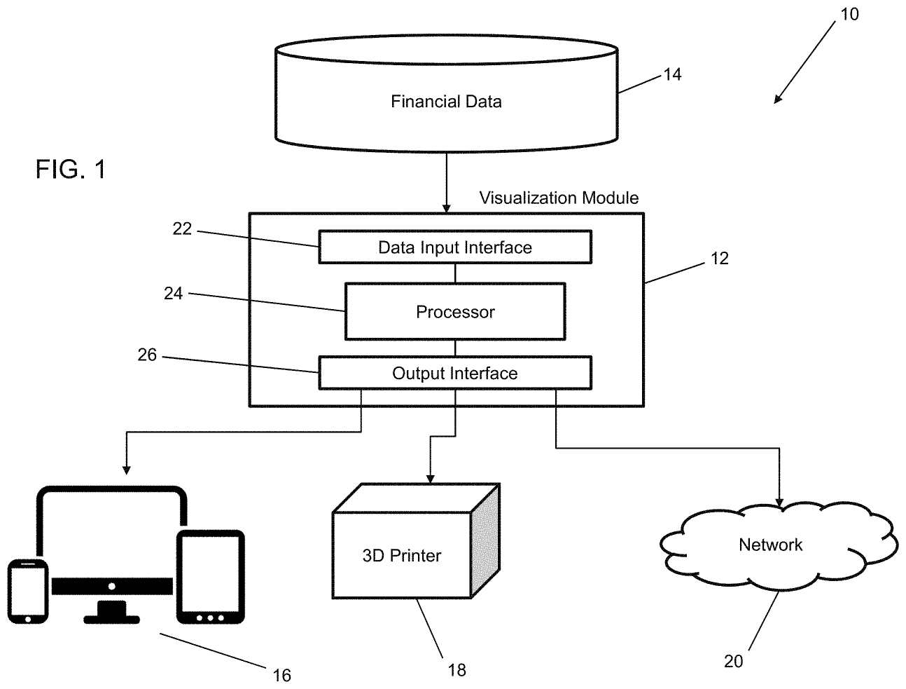

Turning now to the figures, FIG. 1 illustrates an example of a system 10 for generating and rendering such a three-dimensional model. The system 10 includes a visualization module 12 that uses financial data 14 made available to the module 12. It can be appreciated that the module 12 can exist as a separate entity or may be a component of an existing computing system, e.g., as a software module installed on or available via a desktop or mobile computer or other computing system. The visualization module 12 uses the financial data 14 as described below, to generate a three-dimensional model that can be rendered as a physical or virtual output or both. In the example shown in FIG. 1, example outputs for such a rendering include a virtual output shown on the display of an electronic device 16, a physical output generated by a 3D printer 18 or other physical machine, or provided to another system or entity (for subsequent rendering and display/production) via a network 20 such as the internet.

The visualization module 12 includes a data input interface 22 for obtaining the financial data 14 (e.g. from a connected financial institution or other data repository), a processor 24 for executing computer executable instructions to generate the output(s) described herein, and an output interface 26 for interfacing with the various output entities configured to render the output in a particular format.

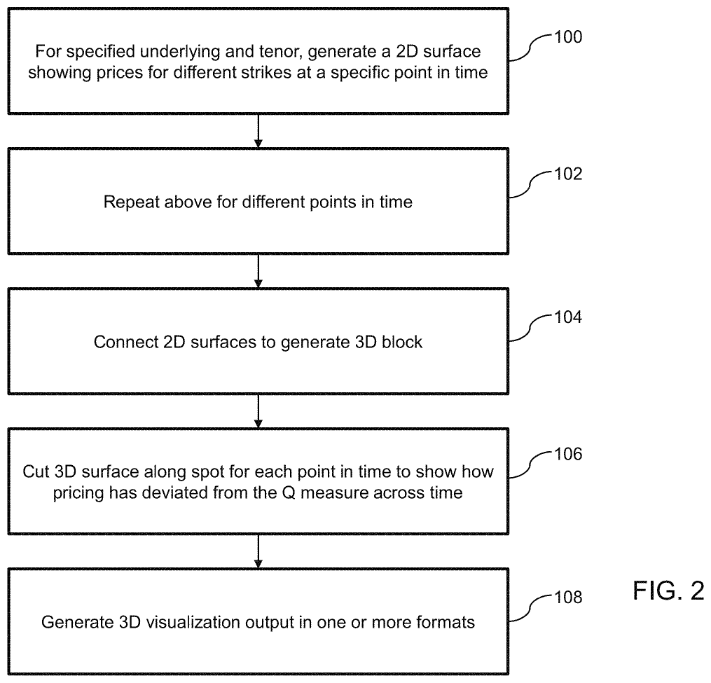

Turning now to FIG. 2, the visualization module 12 is configured to operate, in one example implementation, as follows.

For a specified underlying, and tenor (i.e., option maturity date), the module 12 can first generate a two-dimensional surface to show the prices for different strikes at a specific point in time (step 100).

Next, the module 12 is configured to generate the surface in step 100 above, for different points in time (step 102), and then to connect these two-dimensional surfaces to generate a three-dimensional block (step 104). This then allows the system 10 to identify the pricing evolution of strikes across time, as “implied” by (priced in) the P measure.

The module 12 is configured to then cut this surface along “spot” (the price of buying or selling the underlying with “cash” today, as opposed to a point in the future, which would then require a derivative contract), as it was, for each point in time, and show how pricing (in the Q measure) as per steps 102/104, has deviated from the Q measure (spot), across time (step 106). The system 10 can then generate a three-dimensional visualization output in one or more formats (step 108).

It can be appreciated that the presenting described process that generates an output comprising a three-dimensional rendering of this process is applicable across all major asset classes, namely equity derivatives (including equity and equity volatility linked ETFs), derivatives on equity volatility, FX derivatives, rates derivatives and commodity derivatives.

The fundamental requirement of any volatility (strike) interpolation scheme is that its arbitrage free, meaning that it doesn't give rise to any negative butterfly spreads. Additionally, it is known to be good to avoid point-masses, which will give risk to discontinuous digital prices. Linear interpolation methods, for example, are not found to meet that criterion. Lastly, preferably but optionally the system 10 can be configured to have a continuous density function.

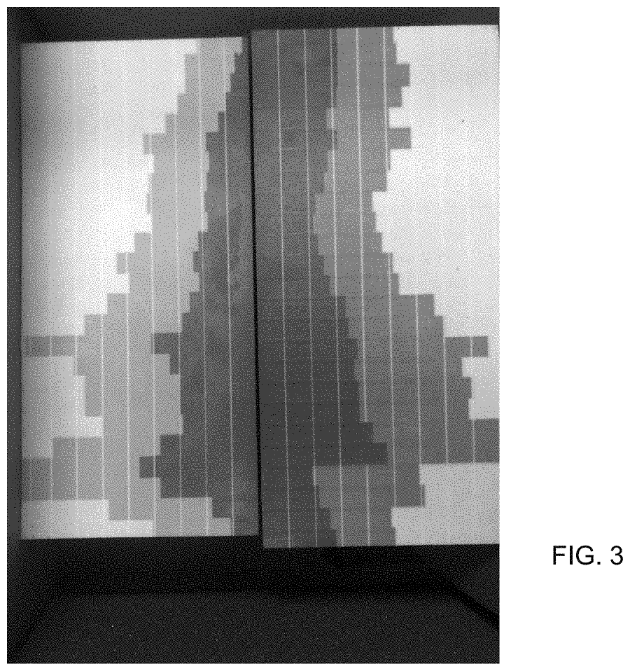

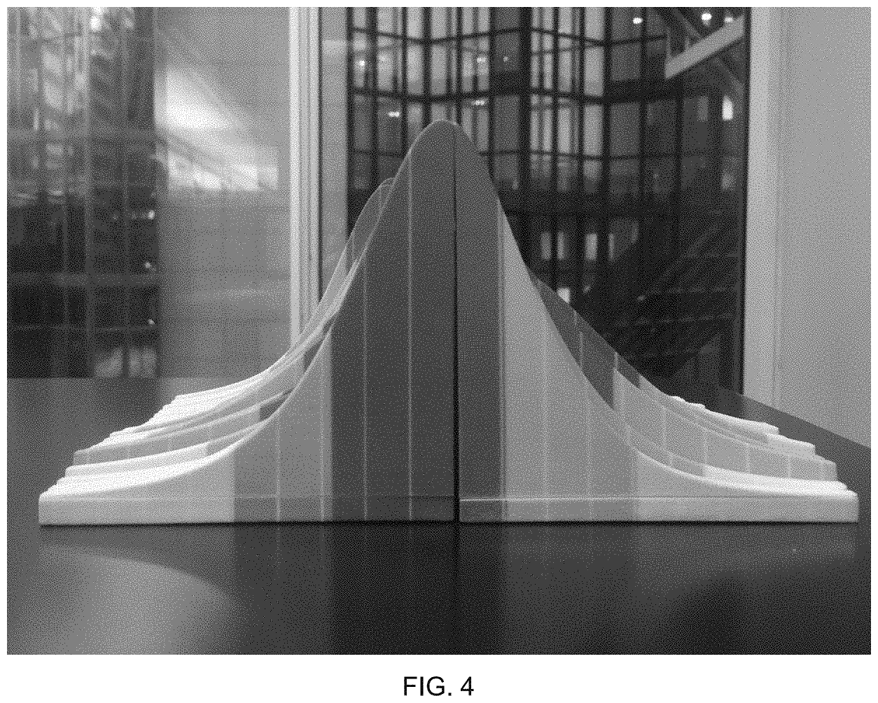

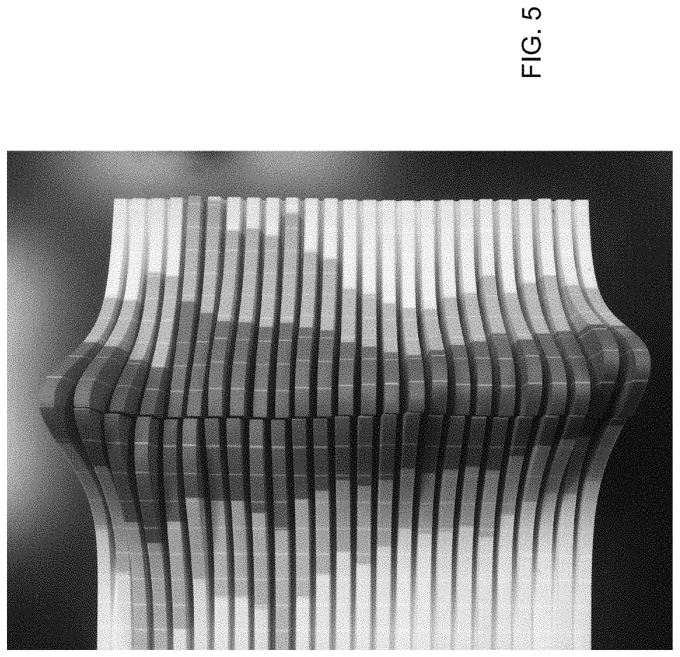

Turning now to FIGS. 3 to 5, images of an example output rendering are shown for a physical model. It can be appreciated that the images shown therein may include certain colors (which specific colors are for illustrative purposes wherein the process in part is concerned with where to put such colors), line spacing that is meant to illustrate specific “moves” in underlying spot and a slit, as per above, which is at spot. The three-dimensional distribution for all financial derivatives in its entirety can be printed according to the principles discussed herein. The following provides examples of how to apply the presently described process to color the portions in a particular way, and to apply particular gradations.

The following methodology and renderings can be used by financial services clients, such as large asset managers, pension funds and insurers, and help them diversify their portfolio beyond the traditional equity and fixed income investments. It is recognized that Vega, or longer-dated volatility, over time, has become a very deep and liquid asset class for G3 (US, Europe and Japan) Equity, FX and Rates, and the system 10 described herein can provide a virtual or physical output that can be used to show these financial services clients which derivatives they should own to be able to generate alpha and hedge their core investments.

That is, over time, it is contemplated that structures such as the longer-dated Euro Stoxx call above can help pension funds, institutional investors and endowments meet return obligations and diversify asset mix.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10 or module 12, any component of or related to the system 10 or module 12, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method comprising:
a) for a specified underlying and tenor, generating a two-dimensional surface showing prices for different strikes at a specific point in time;
b) repeating a) for a plurality of points in time;
c) connecting the two-dimensional surfaces to generate a three-dimensional block;
d) cutting a surface of the three-dimensional block along a spot for each point in time to identifying how pricing has deviated from a Q measure across time; and
e) generating a three-dimensional visualization in one or more formats.

2. The method of claim 1, further comprising rendering the visualization on a display.

3. The method of claim 1, further comprising 3D printing the visualization to generate a physical output.

4. The method of claim 1, further comprising sending the visualization to another entity over a network for subsequent display or printing.
